(19) United States
(12) Patent Application Publication
(10) Pub. No.: US 2003/0088860 A1
(43) Pub. Date: May 8, 2003

(54) Compiler annotation for binary translation tools

(76) Inventor: Fu-Hwa Wang, Saratoga, CA (US)

Correspondence Address: STEPHEN A TERRILE, HAMILTON & TERRILE LLP, PO BOX 203518, AUSTIN, TX, 78759, US

(21) Appl. No.: 10/002,238

(22) Filed: Nov. 2, 2001

(51) Int. Cl. G06F 9/45

(52) U.S. Cl. 717/153

(57) ABSTRACT

An optimizing compiler adds compiler annotation to an executable binary code file. Compiler annotation provides information useful for binary translators such that a binary translator does not have to use a heuristic approach to translate binary code. Compiler annotation identifies such information as function boundaries, split functions, jump table information, function addresses, and code labels. The compiler annotation can be used by a binary translator when translating a source binary code to a target binary code. The target binary code optionally includes new compiler annotation. According to one embodiment of the present invention, an ELF section annotate is generated by an optimizing compiler for each binary code file, aggregated and updated into a single section in the executable binary code by the linker.

### SECTION I

### BACKGROUND OF THE INVENTION

1. Field of the Invention

The present invention relates to the field of binary translators and more particularly optimizing compiler output to improve binary translation by using compiler annotation.

2. Description of the Related Art

Source code written by a programmer is a list of statements in a programming language such as C, Pascal, Fortran and the like. Programmers perform all work in the source code, changing the statements to fix bugs, adding features, or altering the appearance of the source code. A compiler is typically a software program that converts the source code into an executable file that a computer or other machine can understand. The executable file is in a binary format and is often referred to as binary code. Binary code is a list of instruction codes that a processor of a computer system is designed to recognize and execute. Binary code can be executed over and over again without recompilation. The conversion or compilation from source code into binary code is typically a one-way process. Conversion from binary code back into the original source code is typically impossible.

A different compiler is required for each type of source code language and target machine or processor. For example, a Fortran compiler typically can not compile a program written in C source code. Also, processors from different manufacturers typically require different binary code and therefore a different compiler or compiler options because each processor is designed to understand a specific instruction set or binary code. For example, an Apple Macintosh's processor understands a different binary code than an IBM PC's processor. Thus, a different compiler or compiler options would be used to compile a source program for each of these types of computers. Therefore, a program written for an Apple Macintosh typically can not run on an IBM PC. Additionally, operating system differences can prevent a program to run on both systems.

Frequently, software manufacturers release different versions of software, each compiled for different platforms, that is, systems with different operating systems and/or processors. Advances in technology lead to newer architectural design and better performance. The availability of programs to run on newer systems is typically scarce. It is desirable to have existing programs running on new systems as soon as possible. The ability to migrate an existing program to run on a new system depends on the differences of the two system architectures, file structures, and operating system services, and the availability of source code for all libraries included by a program.

Binary translators are one mechanism used for the purpose of migrating software from a source binary code to a target binary code. Binary translation is the process of translating a binary executable program from one platform to another. Binary translation typically involves different machines, different operating systems, and/or different binary-file formats. Binary translation enables the availability of software on new machines at a low cost, without requiring source code or re-programming by reuse of binary code. Binary code translation can be used for a variety of applications including instruction set simulation, virtual machine implementation, software migration, executable editing, program tracing and code instrumentation. Binary translators can also perform code optimization at the binary level instead of at the source level.

Binary translation typically requires detailed information about the contents of the binary code. To perform binary code transformation, binary translators typically use a heuristic approach in which the characteristics of the binary executable such as function boundaries, address and size information, and the like, is guessed. The heuristic approach fails to produce a robust and complete solution and highly depends on the compiler which the product is compiled and the instruction set of the source machine. For example, binary translators have particular trouble with self-modifying code where not all of the code may be available, and indirect jumps in which the entire flow of control may not be able to be reconstructed statically.

### SUMMARY OF THE INVENTION

In accordance with the present invention, an optimizing compiler adds annotation information (compiler annotation) to an executable binary code file. Compiler annotation provides information useful for binary translators such that a binary translator does not have to use a heuristic approach to translate binary code. Compiler annotation identifies such information as function boundaries, split functions, jump table information, function addresses, and code labels. The compiler annotation can be used by a binary translator when translating a source binary code to a target binary code. The target binary code optionally includes new compiler annotation.

According to one embodiment of the present invention, an ELF section annotate is generated by an optimizing compiler for each binary code file, aggregated and updated into a single section in the executable binary code by the linker.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings.

FIGS. 1A-1B, shown as prior art, illustrate an exemplary compiler architecture.

FIGS. 2A-2B, shown as prior art, illustrate an exemplary binary translator architecture.

FIGS. 3A-3C, shown as prior art, illustrate exemplary binary file formats.

FIG. 4 illustrates exemplary annotate records according to the present invention.

FIGS. 5A-5B illustrate flow diagrams of compilation and binary translation processes with annotation capability according to embodiments of the present invention.

The use of the same reference symbols in different drawings indicates similar or identical items.

### DETAILED DESCRIPTION

The following is intended to provide a detailed description of an example of the invention and should not be taken to be limiting of the invention itself. Rather, any number of variations may fall within the scope of the invention that is defined in the claims following the description.

Introduction

According to the present invention, an optimizing compiler adds compiler annotation to an executable binary code file. Compiler annotation provides information useful for binary translators such that a binary translator does not have to use a heuristic approach to translate binary code. The compiler annotation can be used by a binary translator when translating a source binary code to a target binary code. The target binary code optionally includes new compiler annotation.

Compiler annotation identifies such information as function boundaries, split functions, jump table information, function addresses, and code labels. This information is readily available by analyzing the source code. However, this information is lost when the source code is compiled into binary code by a typical compiler.

According to one embodiment of the present invention, an ELF section .annotate is generated by an optimizing compiler for each binary code file, aggregated and updated into a single section in the executable binary code by the linker. A minimum set of annotation records for binary translation is provided. Preferably, the size of the annotation section has only a small impact on the size of the executable binary code and compile and link times, for example, less than three percent.

In an alternate embodiment of the present invention, binary code can consist of multiple files. A compiler can produce multiple file outputs and a binary translator can read in multiple files. For example, compiler annotation can be included in the binary code as described above, or it can be placed in a separate file.

Compilation

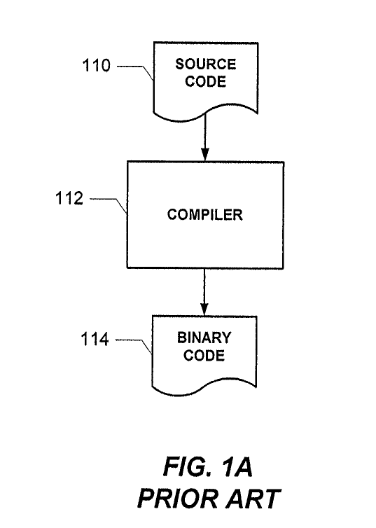

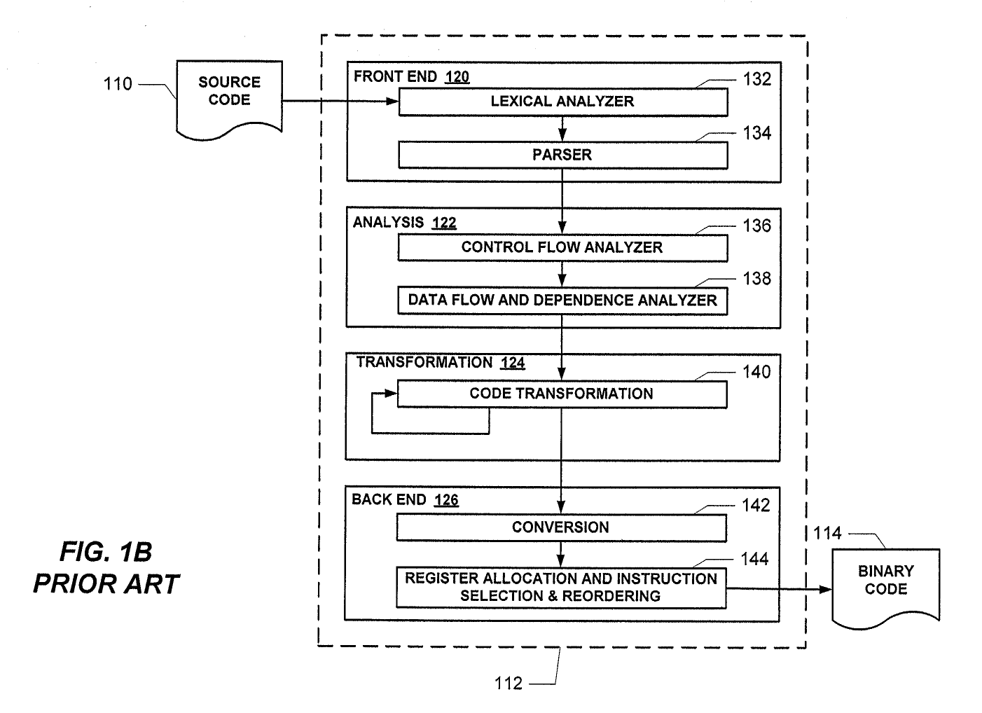

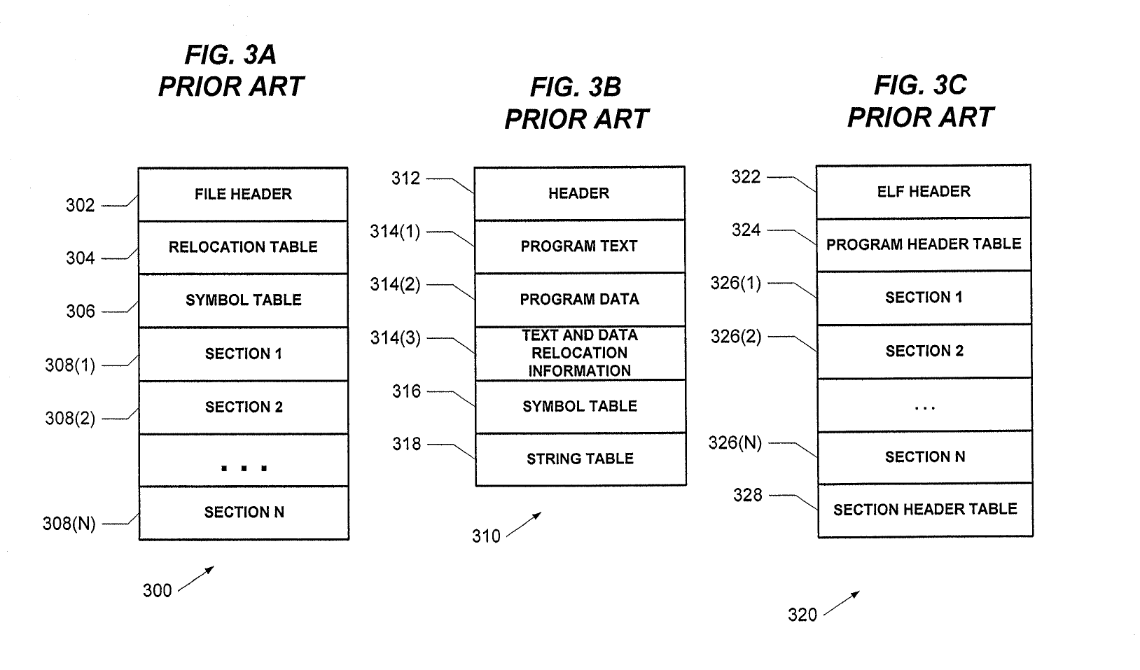

FIG. 1A, shown as prior art, illustrates an exemplary compilation process. Source code 110 is read into compiler 112. Source code 112 is a list of statements in a programming language such as C, Pascal, Fortran and the like. Compiler 112 collects and reorganizes (compiles) all of the statements in source code 110 to produce a binary code 114. Binary code 114 is an executable file in a binary format and is a list of instruction codes that a processor of a computer system is designed to recognize and execute. Exemplary binary file formats for binary code 114 are shown in FIGS. 3A-3C. An exemplary compiler architecture is shown in FIG. 1B.

In the compilation process, compiler 112 examines the entire set of statements in source code 110 and collects and reorganizes the statements. Each statement in source code 110 can translate to many machine language instructions or binary code instructions in binary code 114. There is seldom a one-to-one translation between source code 110 and binary code 114. During the compilation process, compiler 112 may find references in source code 110 to programs, sub-routines and special functions that have already been written and compiled. Compiler 112 typically obtains the reference code from a library of stored sub-programs which is kept in storage and inserts the reference code into binary code 114. Binary code 114 is often the same as or similar to the machine code understood by a computer. If binary code 114 is the same as the machine code, the computer can run binary code 114 immediately after compiler 112 produces the translation. If binary code 114 is not in machine language, other programs (not shown) such as assemblers, binders, linkers, and loaders-finish the conversion to machine language. Compiler 112 differs from an interpreter, which analyzes and executes each line of source code 110 in succession, without looking at the entire program.

FIG. 1B, shown as prior art, illustrates an exemplary compiler architecture for compiler 112. Compiler architectures can vary widely; the exemplary architecture shown in FIG. 1B includes common functions that are present in most compilers. Other compilers can contain fewer or more functions and can have different organizations. Compiler 112 contains a front-end function 120, an analysis function 122, a transformation function 124, and a back-end function 126.

Front-end function 120 is responsible for converting source code 110 into more convenient internal data structures and for checking whether the static semantic constraints of the source code language have been properly satisfied. Front-end function 120 typically includes two phases, a lexical analyzer 132 and a parser 134. Lexical analyzer 132 separates characters of the source language into groups that logically belong together, these groups are referred to as tokens. The usual tokens are keywords, such as DO or IF, identifiers, such as X or NUM, operator symbols, such as <= or +, and punctuation symbols such as parentheses or commas. The output of lexical analyzer 132 is a stream of tokens, which is passed to the next phase, parser 134. The tokens in this stream can be represented by codes, for example, DO can be represented by 1, + by 2, and “identifier” by 3. In the case of a token like “identifier,” a second quantity, telling which of those identifiers used by the code is represented by this instance of token “identifier,” is passed along with the code for “identifier.” Parser 134 groups tokens together into syntactic structures. For example, the three tokens representing A+B might be grouped into a syntactic structure called an expression. Expressions might further be combined to form statements. Often the syntactic structure can be regarded as a tree whose leaves are the tokens. The interior nodes of the tree represent strings of tokens that logically belong together.

Analysis function 122 can take many forms. A control flow analyzer 136 produces a control-flow graph (CFG). The control-flow graph converts the different kinds of control transfer constructs in source code 110 into a single form that is easier for compiler 112 to manipulate. A data flow and dependence analyzer 138 examines how data is being used in source code 110. Analysis function 122 typically uses program dependence graphs and static single-assignment form, and dependence vectors. Some compilers only use one or two of the intermediate forms, while others use entirely different ones.

After analyzing source code 110, compiler 112 can begin to transform source code 110 into a high-level representation. Although FIG. 1B implies that analysis function 122 is complete before transformation function 124 is applied, in practice it is often necessary to re-analyze the resulting code after source code 110 has been modified. The primary difference between the high-level representation code and binary code 114 is that the high-level representation code need not specify the registers to be used for each operation.

Code optimization (not shown) is an optional phase designed to improve the high-level representation code so that binary code 114 runs faster and/or takes less space. The output of code optimization is another intermediate code program that does the same job as the original, but perhaps in a way that saves time and/or space.

Once source code 110 has been fully transformed into a high-level representation, the last stage of compilation is to convert the resulting code into binary code 114. Back-end function 126 contains a conversion function 142 and a register allocation and instruction selection and reordering function 144. Conversion function 142 converts the high-level representation used during transformation into a low-level register-transfer language (RTL). RTL can be used for register allocation, instruction selection, and instruction reordering to exploit processor scheduling policies.

A table-management portion (not shown) of compiler 112 keeps tack of the names used by the code and records essential information about each, such as its type (integer, real, etc.). The data structure used to record this information is called a symbol table.

Binary Translation

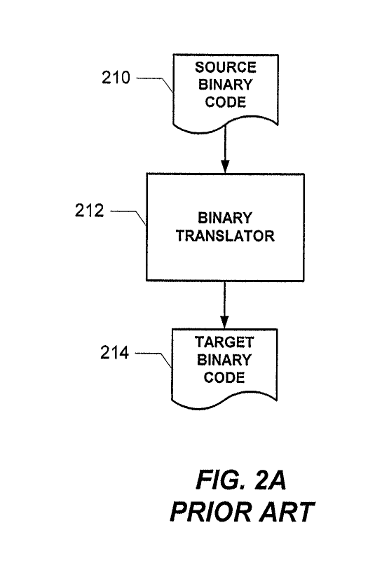

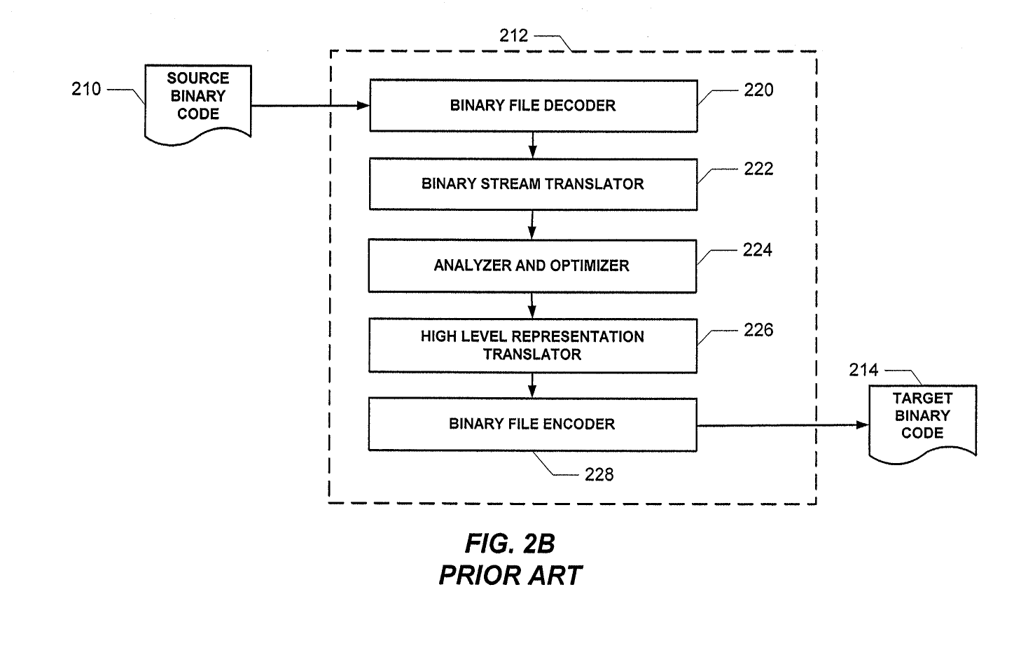

FIG. 2A, prior art, illustrates an exemplary binary translation process. Source binary code 210 is read into binary translator 212. Binary translator 212 outputs target binary code 214. Source binary code 210 can be, for example, binary code 114 output from compiler 112. Source binary code 210 is an executable file in a binary format and is a list of instruction codes that a processor of a source computer system is designed to recognize and execute. Target binary code 214 is an executable file in a different binary format and is a list of instruction codes that a processor of a target computer system is designed to recognize and execute. An exemplary architecture for binary translator 212 is shown in FIG. 2B.

FIG. 2B, prior art, illustrates an exemplary binary translator architecture for binary translator 212. Binary translator architectures can vary widely; the exemplary architecture shown in FIG. 2B includes common functions that are present in most binary translators. Other binary translators can contain fewer or more functions and can have different organizations.

Binary translator 212 performs code transformation and optimization on fully compiled and linked executable files such as binary code 210. Binary translator 212 can be used to analyze program behavior/performance by profiled code instrumentation and to perform code optimization at the binary level instead of at the source level. Along each of the binary translation steps, the addresses of some instructions may have to be relocated due to changes in code size.

Binary translator 212 contains a binary file decoder 220, a binary stream translator 222, an analyzer and optimizer 224, a high-level representation translator 226 and a binary file encoder 228. Binary file decoder 220 reads in source binary code 210, disassembles the binary code and produces a binary stream. Binary stream translator 222 translates the binary stream into a high-level intermediate representation. Binary stream translators that use a heuristic approach use knowledge of the code generation pattern from the compiler to assist translation. However, the knowledge is a guess of the information and depends on the compiler conventions on which source binary code 210 was produced.

Analyzer and optimizer 224 map the source-machine locations to target-machine locations, and may apply other machine-specific optimizations. High-level representation translator 226 translates the intermediate high-level representation code to target-machine instructions. Binary file encoder 228 writes target binary code 214 in the required format.

FIG. 3A, prior art, illustrates an exemplary generic binary file format 300. Binary file format 300 includes a file header 302, a relocation table 304, a symbol table 306, and multiple sections or segments, sections 308(1)-(N). File header 302 typically contains general information and information needed to access various parts of the file. Relocation table 304 typically contains records used by a link editor to update pointers when combining binary files. Symbol table 306 typically contains records used by the link editor to cross reference addresses of named variables and functions or symbols between binary files. Sections 308(1)-(N) typically contain code and data.

FIG. 3B, prior art, illustrates the file format of an a. out binary file 310. A. out is the default output format on Unix systems of a system assembler and a link editor. The link editor makes a.out executable files. A file in a.out format typically contains a header 312, a program text section 314(1), a program data section 314(2), a text and data relocation information section 314(3), a symbol table 316, and a string table 318. In header 312, the sizes of each section are given in bytes. The last three fields, text and data relation information 318, symbol table 320 and string table 322 are optional.

Header 312 contains parameters used by a processor to load a binary file into memory and execute it, and by a link editor to combine a binary file with other binary files. Header 312 is the only required section. Program text 314(1), also referred to as a .text segment, contains machine code and related data that are loaded into memory when a program executes. Program data 314(2), also referred to as a .data segment, contains initialized data. Text and data relocation information 314(3), also referred to as a .bss segment, contains records used by the link editor to update pointers in the .text and .data segments when combining binary files. Symbol table 316 contains records used by the link editor to cross-reference the addresses of named variables and functions or symbols between binary files. String table 318 contains the character strings corresponding to the symbol names.

FIG. 3C, prior art, illustrates the file format of an Executable and Linking Format (ELF) executable binary file 320. Executable binary file 320 contains an ELF header 322, a program header table 324, one or more sections 326(1)-(N) and a section header table 328. ELF header 322 is always at offset zero of the file. The offset of program header table 324 and section header table 328 in the file are defined in ELF header 322. Program header table 324 is an array of structures, each describing a segment or other information the system needs 20 to prepare the program for execution. Section header table 328 describes the location of all of sections 326(1)-(N). Section table 328 enables the ELF file format to support more than the .text, .data. and .bss sections as supported by a.out binary file 310. Table 1 illustrates some of the sections and their functions in an ELF executable binary file.

TABLE 1

| Section | Description |
|---|---|
| .bss | This section holds uninitialized data that contributes |
| | to the program's memory image. |
| .comment | This section holds version control information. |
| .data | This section holds initialized data that contribute to |
| | the program's memory image. |
| .data1 | This section holds initialized data that contribute to |
| | the program's memory image. |
| .debug | This section holds information for symbolic debugging |
| .dynamic | This section holds dynamic linking information. |
| .dynstr | This section holds strings needed for dynamic linking, |
| | most commonly the strings that represent the names |
| | associated with symbol table entries. |
| .dynsym. | This section holds the dynamic linking symbol table |
| .fini | This section holds executable instructions that contribute |
| | to the process termination code. |
| .got | This section holds the global offset table. |
| .hash | This section holds a symbol hash table. |
| .init | This section holds executable instructions that contribute |
| | to the process initialization code. |
| .interp | This section holds the pathname of a program interpreter. |
| .line | This section holds line number information for |
| | symbolic debugging, which describes the correspondence |
| | between the program source and the machine code. |
| .note | This section holds information in the “Note Section” |
| | format. |
| .plt | This section holds the procedure linkage table. |
| .reINAME | This section holds relocation information. |
| .relaNAME | This section holds relocation information. |
| .rodata | This section holds read-only data that typically contributes |
| | to a non-writable segment in the process image. |
| .rodatal | This section holds read-only data that typically contributes |
| | to a non-writable segment in the process image. |
| .strtab | This section holds strings, most commonly the strings that |
| | represent the names associated with symbol table entries. |
| .symtab | This section holds a symbol table. |
| .text | This section holds the “text”, or executable instructions, |
| | of a program. |

Compiler Annotation and Binary Translation

According to an embodiment of the present invention, an optimizing compiler adds compiler annotation to an executable binary code file. Compiler annotation provides information useful for binary translators such that a binary translator does not have to use a heuristic approach to translate binary code. The compiler annotation can be used by binary translation tools when translating a source binary code to a target binary code.

Compiler annotation identifies such information as function boundaries, split functions, jump table information, function addresses, and code labels. This information is readily available by analyzing the source code. However, this information is lost when the source code is compiled into binary code by a typical compiler.

According to one embodiment, an ELF section annotate is generated by an optimizing compiler for each binary code file, aggregated and updated into a single section in the executable binary code by the linker. A minimum set of annotation records for binary translation is provided. Preferably, the size of the annotation section has only a small impact on the size of the executable binary code and compile and link times, for example, less than three percent.

In an alternate embodiment of the present invention, binary code can consist of multiple files. A compiler can produce multiple file outputs and a binary translator can read in multiple files. For example, compiler annotation can be included in the binary code as described above, or it can be placed in a separate file.

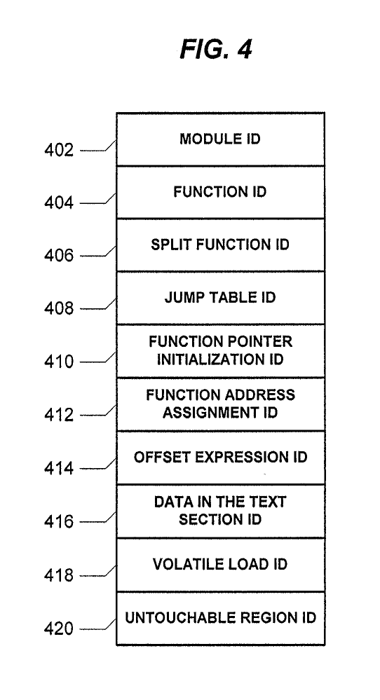

FIG. 4A illustrates exemplary records that can be included as a .annotate section in an ELF executable binary file. The compiler annotation is generated by an optimizing compiler and added to the binary code file. The compiler annotation can be used by a binary translator during the translation of a source binary code file. Based on the structure and unique characteristics of the source code, multiple records can be included in the annotate section. There is typically one annotate section per binary code file with multiple records (i.e., records such as illustrated in Section II. Exemplary records include a module identification (ID) record 402, a function ID record 404, a split function ID record 406, a jump table ID record 408, a function pointer initialization ID record 410, a function address assignment ID record 412, an offset expression ID record 414, a data in the text section ID record 416, a volatile load ID record 418, and an untouchable region ID record 420. See Section II for exemplary .annotate record formats written as C structures.

Module ID record 402 can be used to link individual functions to the binary code file, which can aid the analysis of the entire binary code file.

Function ID record 404 can be used to identify the boundaries of a function, which can aid in distinguishing the code and data space of the binary code file. For example, any code in the. text section that is not within the boundary of all functions should be treated as data. Identification of function boundaries can also be used to define a basic unit on call graph generation and for code optimization. For example, function ordering can be used to maximize instruction caching. Function ID record 404 can also indicate the original source language used, which allows assumption of some language specific features and characteristics. For example, function addresses are never taken in Fortran source code programs.

Split function ID record 406 can be used to identify functions that are part of some other functions. These special constructs occur, for example, when Fortran ENTRY statements are used or when hot/cold function splitting optimization is performed. Without split function information, it is possible that some code may be mistreated as data.

Jump table ID record 408 can be used to for control flow building when, for example, a source code program uses a ‘jmpl’ instruction. Jump table information is use to build a basic block predecessor/successor link and identify data in the .text section. Without jump table information, some data may be mistreated as code and some code may be mistreated as unreachable or dead code.

Function pointer initialization ID record 410 can be used to identify function addresses in the data section that need to be updated when the address of a function is changed during binary transformation. Function pointer initialization information can be generated, for example, when a function address is used to initialize a function pointer.

Function address assignment ID record 412 can be used to identify function addresses and other code labels which are used by, for example, ‘sethi’/‘or’ instructions, to generate code addresses. Code addresses used in these instructions need to be updated when an address of code is changed during binary transformation. Function address assignment information is generated, for example, when an address of a function is taken by the executable binary code.

Offset expression ID record 414 can be used to identify expressions including code addresses in the .data section. The identified expressions need to be updated when an address of code is changed during binary transformation. Offset expression information can be generated, for example, when an exception table is used for a C++ try/catch.

Data in the text section ID record 416 can be used to identify code labels and a current program counter which are used by, for example, ‘sethi’/‘or’ instructions to generate position independent code. Code addresses used in these instructions need to be updated when an address of code is changed during binary transformation.

Volatile load ID record 418 can be used to identify the address of a volatile load. A volatile memory reference must not be removed or re-ordered with respect to other volatile memory references.

Untouchable region ID record 420 can be used to identify a region of code that can not be moved to different address, can not be optimized, and can not be ordered. Examples of the special code identified by the untouchable region information includes position independent code, functions that contain an “asm” statement, and code that contains branches into the middle of basic blocks.

Each of the records in the annotate section typically contain one or more fields. An identification field and an annotation size field can be used by, for example, module ID record 402 to indicate the beginning of the .annotate section. The size field can be used to skip to the next section. A record identification and record size field can be used to describe the record and can also be used to skip to the next record. Other fields are shown in the exemplary records in Section II.

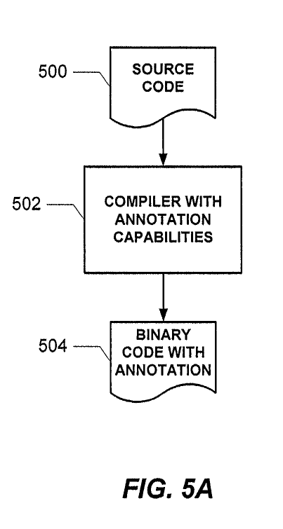

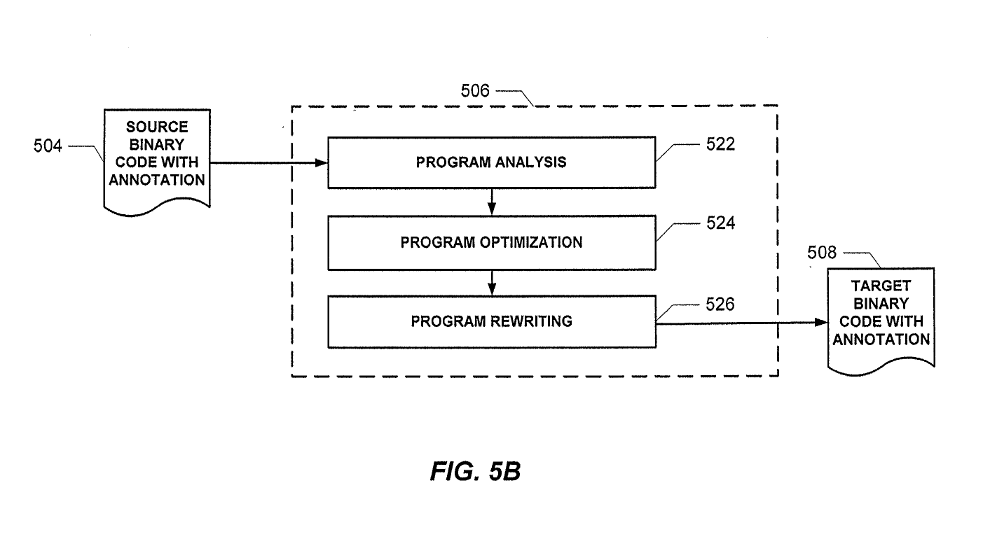

FIG. 5A illustrates a compilation process according to embodiments of the present invention. Source code 500 is read into a compiler with annotation capabilities 502. Source code 500 can be, for example, source code 112. Source code 500 can be a list of statements in a programming language such as C, Pascal, Fortran and the like. Compiler with annotation capabilities 502 outputs a binary code with annotation 504. Binary code with annotation 504 can be, for example, an ELF binary code file with compiler annotation included as a section.

FIG. 5B illustrates a translation process according to embodiments of the present invention. Source binary code with annotation 504 is read into binary translator with annotation capabilities 506. Source binary code with annotation 504 can be an executable file in a binary format and can be a list of instruction codes that a processor of a source computer system is designed to recognize and execute. Binary translator with annotation capabilities 506 outputs a target binary code with annotation 508. Target binary code with annotation 508 can be an executable file in a different binary format and can be a list of instruction codes that a processor of a target computer system is designed to recognize and execute. Binary translator with annotation capabilities 506 includes, among other functions, a program analysis function 522, a program optimization function 524, and a program rewriting function 526.

Program analysis function 522 uses compiler annotation and control flow analysis to partition source binary code with annotation 504 into sections, functions and basic blocks. Program analysis function 522 builds a Control-Flow Graph (CFG) from source binary code with annotation 504. A CFG is a graph whose vertices are basic blocks. CFGs are used in program optimization function 524 and program rewriting function 526. To construct an accurate CFG, every word in the. text section of source binary code with annotation 504 needs to be identified as belonging to a certain function and basic block, and every word needs to be identified as executable code or constant data. Function ID 404, split function ID 406, jump table ID 408, and data in the text section ID 416 provide the necessary program information to construct an accurate CFG. Without the compiler annotation, binary translation must use an incomplete symbol table of an executable and a heuristic-based approach using patterns in the code that a compiler generates. A heuristic-based approach is undesirable because it produces an unreliable and inaccurate product because code patterns typically change from different compilers and different releases of the compilers.

Program optimization function 524 performs code transformation and optimization. Optimizations performed include instruction scheduling, value numbering, code ordering and other optimizations that can only be performed at a binary level. Program optimization function 524 can rely on profile information provided by a compiler for code optimization. Most of the optimizations performed on source binary code with annotation 504 rely on accurate control flow and data flow analysis. Incorrect code can be generated when wrong control flow and data flow analysis is used. Untouchable region ID 420 provides the information about functions and basic blocks of which accurate control flow may not be able to be obtained. Preferably, program optimization function 524 avoids performing any optimization in these regions.

Program rewriting function 526 assigns new addresses to functions and basic blocks after code transformation. Control Transfer Instructions (CTIs) are updated to reflect the new address changes. Any address generation instruction and address initialization in the data section can be also updated. A new executable target binary code with annotation 508, is created based on CFGs and updated addresses. An update of the compiler annotation section can also be performed to reflect code address changes. The updated compiler annotation allows target binary code with annotation 508 to be further optimized. Jump table ID 408, function address assignment ID 412, and offset expression ID 414, are used to identify code labels used in the .text and .data sections.

According to an embodiment of the present invention, binary translator with annotation capabilities 506 performs static binary translation, does not need dynamic run-time support, special operating system or library support, or special linker support. In addition, binary translator with annotation capabilities does not use a heuristic approach to produce a robust translation of source binary code with annotation 504.

In an alternate embodiment of the present invention, binary translator with annotation capabilities 506 optionally provides compiler annotation in a target binary code file.

FIGS. 5A-5B illustrate flow diagrams of compilation and binary translation processes with annotation capability according to embodiments of the present invention. It is appreciated that operations discussed herein may consist of directly entered commands by a computer system user or by steps executed by application specific hardware modules, but the preferred embodiment includes steps executed by software modules. The functionality of steps referred to herein may correspond to the functionality of modules or portions of modules.

The operations referred to herein may be modules or portions of modules (e.g., software, firmware or hardware modules). For example, although the described embodiment includes software modules and/or includes manually entered user commands, the various exemplary modules may be application specific hardware modules. The software modules discussed herein may include script, batch or other executable files, or combinations and/or portions of such files. The software modules may include a computer program or subroutines thereof-encoded on computer-readable media.

Additionally, those skilled in the art will recognize that the boundaries between modules are merely illustrative and alternative embodiments may merge modules or impose an alternative decomposition of functionality of modules. For example, the modules discussed herein may be decomposed into sub-modules to be executed as multiple computer processes. Moreover, alternative embodiments may combine multiple instances of a particular module or sub-module. Furthermore, those skilled in the art will recognize that the operations described in exemplary embodiment are for illustration only. Operations may be combined or the functionality of the operations may be distributed in additional operations in accordance with the invention.

Other embodiments are within the following claims. Also, while particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

[image]

[image]

[image]

[image]

What is claimed is:

1. A method of producing a binary code file comprising:
compiling a plurality of source code instructions; and
outputting a plurality of binary code instructions and compiler annotation.

2. The method as recited in claim 1, wherein the compiler annotation enables binary translation to be performed on the plurality of binary code instructions using a non-heuristic approach.

3. The method as recited in claim 1, wherein the compiler annotation describes functional characteristics of the plurality of binary code instructions.

4. The method as recited in claim 1, wherein the compiler annotation comprises one or more records selected from a module identification (ID), a function ID, a split function ID, a jump table ID, a function pointer initialization ID, a function address assignment ID, an offset expression ID, a data in the text section ID, a volatile load ID, and an untouchable region ID.

5. The method as recited in claim 1, wherein the compiling the plurality of source code instructions comprises:
examining the plurality of source code instructions;
reorganizing one or more of the plurality of source code instructions;
translating the plurality of source code instructions into the plurality of binary code instructions;
reorganizing one or more of the plurality of binary code instructions; and
tracking and recording functional characteristics of the plurality of source code instructions and of the plurality of binary code instructions.

6. The method as recited in claim 1, wherein the plurality of binary code instructions is an ELF format binary code file and the compiler annotation is an ELF section.

7. The compiler annotation created by the method of claim 1.

8. A method of translating a source binary code file comprising:
translating a plurality of source binary code instructions utilizing compiler annotation; and
outputting a plurality of target binary code instructions.

9. The method as recited in claim 8, wherein the compiler annotation enables the translating the plurality of source binary code instructions to be performed on the plurality of source binary code instructions using a non-heuristic approach.

10. The method as recited in claim 8, wherein the compiler annotation describes functional characteristics of the plurality of binary code instructions.

11. The method as recited in claim 8, wherein the compiler annotation comprises one or more records selected from a module identification (ID), a function ID, a split function a jump table ID, a function pointer initialization ID, a function address assignment ID, an offset expression ID, a data in the text section ID, a volatile load ID, and an untouchable region ID.

12. The method as recited in claim 8, wherein the translating the plurality of source binary code instructions comprises:
utilizing the compiler annotation to partition the plurality of source binary code instructions into sections, functions and basic blocks; and
building a control-flow graph utilizing the plurality of source binary code instructions and the compiler annotation.

13. The method as recited in claim 8, wherein the plurality of source binary code instructions is an ELF format binary code file and the compiler annotation is an ELF section.

14. The method as recited in claim 8, further comprising:
outputting different compiler annotation.

15. The plurality of target binary code instructions and the different compiler annotation created by the method of claim 14.

16. A binary code file comprising:
a plurality of binary code instructions; and
compiler annotation;
wherein the compiler annotation enables a binary translator to:
utilize the compiler annotation to partition the plurality of binary code instructions into sections, functions and basic blocks; and
build a control-flow graph utilizing the plurality of binary code instructions and the compiler annotation.

17. The binary code file as recited in claim 16, wherein the compiler annotation section enables binary translation to be performed on the plurality of binary code instructions using a non-heuristic approach.

18. The binary code file as recited in claim 16, wherein the compiler annotation describes functional characteristics of the plurality of binary code instructions.

19. The binary code file as recited in claim 16, wherein the compiler annotation comprises one or more records selected from a module identification (ID), a function ID, a split function ID, a jump table ID, a function pointer initialization ID, a function address assignment ID, an offset expression ID, a data in the text section ID, a volatile load ID, and an untouchable region ID.

20. The binary code file as recited in claim 16, wherein the plurality of binary code instructions and compiler annotation is an ELF format binary code file and the compiler annotation is an ELF section.

21. An apparatus for producing a binary code file comprising:
means for compiling a plurality of source code instructions; and
means for outputting a plurality of binary code instructions and compiler annotation.

22. The apparatus as recited in claim 21, wherein the compiler annotation enables binary translation to be performed on the plurality of binary code instructions using a non-heuristic approach.

23. The apparatus as recited in claim 21, wherein the compiler annotation describes functional characteristics of the plurality of binary code instructions.

24. The apparatus as recited in claim 21, wherein the compiler annotation comprises one or more records selected from a module identification (ID), a function ID, a split function ID, a jump table ID, a function pointer initialization ID, a function address assignment ID, an offset expression ID, a data in the text section ID, a volatile load ID, and an untouchable region ID.

25. The apparatus as recited in claim 21, wherein the means for compiling the plurality of source code instructions comprises:
means for examining the plurality of source code instructions;
means for reorganizing one or more of the plurality of source code instructions;
means for translating the plurality of source code instructions into the plurality of binary code instructions;
means for reorganizing one or more of the plurality of binary code instructions; and
means for tracking and recording functional characteristics of the plurality of source code instructions and of the plurality of binary code instructions.

26. An apparatus for translating a source binary code file comprising:
means for translating a plurality of source binary code instructions utilizing compiler annotation; and
means for outputting a plurality of target binary code instructions.

27. The apparatus as recited in claim 26, wherein the compiler annotation enables the translating the plurality of source binary code instructions to be performed on the plurality of source binary code instructions using a non-heuristic approach.

28. The apparatus as recited in claim 26, wherein the compiler annotation describes functional characteristics of the plurality of binary code instructions.

29. The apparatus as recited in claim 26, wherein the compiler annotation comprises one or more records selected from a module identification (ID), a function ID, a split function ID, a jump table ID, a function pointer initialization ID, a function address assignment ID, an offset expression ID, a data in the text section ID, a volatile load ID, and an untouchable region ID.

30. The apparatus as recited in claim 26, wherein the means for translating the plurality of source binary code instructions comprises:
means for utilizing the compiler annotation to partition the plurality of source binary code instructions into sections, functions and basic blocks; and
means for building a control-flow graph utilizing the plurality of source binary code instructions and the compiler annotation.

31. An apparatus for producing a binary code file comprising:
a computer readable medium; and
instructions stored on the computer readable medium to:
compile a plurality of source code instructions; and
output a plurality of binary code instructions and compiler annotation.

32. The apparatus as recited in claim 31, wherein the compiler annotation enables binary translation to be performed on the plurality of binary code instructions using a non-heuristic approach.

33. The apparatus as recited in claim 31, wherein the compiler annotation describes functional characteristics of the plurality of binary code instructions.

34. The apparatus as recited in claim 31, wherein the compiler annotation comprises one or more records selected from a module identification (ID), a function ID, a split function ID, a jump table ID, a function pointer initialization ID, a function address assignment ID, an offset expression ID, a data in the text section ID, a volatile load ID, and an untouchable region ID.

35. The apparatus as recited in claim 31, wherein the instructions to compile the plurality of source code instructions comprises instructions to:
examine the plurality of source code instructions;
reorganize one or more of the plurality of source code instructions;
translate the plurality of source code instructions into the plurality of binary code instructions;
reorganize one or more of the plurality of binary code instructions; and
track and record functional characteristics of the plurality of source code instructions and of the plurality of binary code instructions.

36. An apparatus for translating a source binary code file comprising:
a computer readable medium; and
instructions stored on the computer readable medium to:
translate a plurality of source binary code instructions utilizing compiler annotation; and
output a plurality of target binary code instructions.

37. The apparatus as recited in claim 36, wherein the compiler annotation enables the translating the plurality of source binary code instructions to be performed on the plurality of source binary code instructions using a non-heuristic approach.

38. The apparatus as recited in claim 36, wherein the compiler annotation describes functional characteristics of the plurality of binary code instructions.

39. The apparatus as recited in claim 36, wherein the compiler annotation comprises one or more records selected from a module identification (ID), a function ID, a split function ID, a jump table ID, a function pointer initialization ID, a function address assignment ID, an offset expression ID, a data in the text section ID, a volatile load ID, and an untouchable region ID.

40. The apparatus as recited in claim 36, wherein the instructions to translate the plurality of source binary code instructions comprises instructions to:
utilize the compiler annotation to partition the plurality of source binary code instructions into sections, functions and basic blocks; and
build a control-flow graph utilizing the plurality of source binary code instructions and the compiler annotation.
